(19) United States
(12) Patent Application Publication
(10) Pub. No.: US 2006/0267888 A1
(43) Pub. Date: Nov. 30, 2006

(54) Driver circuit for an organic active matrix display

(75) Inventors: Li-Chi Lin, Hsinchu (TW); Chung-Hui Tsai, Hsinchu (TW)

Correspondence Address: Bo-In Lin, 13445 Mandoli Drive, Los Altos Hills, CA, 94022, US

(73) Assignee: DELTA OPTOELECTRONICS COMP

(21) Appl. No.: 11/441,544

(22) Filed: May 26, 2006

(30) Foreign Application Priority Data
May 26, 2005 (TW) 094117324

(51) Int. Cl. G09G 3/32

(52) U.S. Cl. 345/83

(57) ABSTRACT

The present invention discloses a color display system. The color display system includes a plurality of light emitting polymer (LEP) optical fibers each formed as plurality of light-emitting segments for emitting a specific color by using a special light emitting polymer. The light emitting segments are arranged as a two-dimensional array with each of the light emitting segments controlled to turn on and off for presenting a color image by turning on a plurality of the light emitting segments. In a preferred embodiment, each of the light emitting segments includes an indium/tin oxide (ITO) layer segment covering the LEP optical fiber wherein each of the ITO segments is connected to an ITO control voltage for turning on and off the light emitting segment.

This Application claims a Priority Filing Date of May 26, 2005 benefited from a previously filed Taiwanese Application No. 094117324 and Serial No, 09420542720 with a certified copy of the Taiwanese Application submitted herein with this Application.

### BACKGROUND OF THE INVENTION

1. Field of the Invention

This invention relates generally to an image display system and a driving circuit of the display system. More particularly, this invention relates to a new and improved driver circuit and method of operation for an active matrix display system to drive the organic light emitting diode.

2. Description of the Prior Art

A technical difficulty is still confronted by those of ordinary skill in the art of the image display industries due to the gradually increase of threshold voltage and the gradual decrease of driving current for the organic light emitting diodes in an image display system. Furthermore, for a driving circuit implemented with the amorphous silicon transistors, such increase of threshold voltage and decrease of driving current cannot conveniently corrected by compensation circuits. Specifically, in an active matrix display system, the driving circuits for the light emitting diodes are commonly manufactured with either the amorphous silicon transistors or low temperature polysilicon thin film transistors. There are technical limitations inherent to the driving circuits that are manufactured with amorphous silicon. A first limitation is caused by a lower speed of electron movement in the amorphous silicon. A second limitation is to manufacture the driving circuits in very limited space. Due to the lower speed of electron movement and the limited space available for the driving circuits, the driving circuits manufactured by amorphous silicon can only be implemented with simple circuits.

In order to avoid such limitations, the driving circuits to drive the light emitting diodes in a display system that are implemented with compensation functions to assure sufficient driving current are generally manufactured with low temperature polysilicon thin film transistors. However, the driving circuits implemented with the low temperature polysilicon thin film transistors are more costly to manufacture due to a lower production yield when compared that can be achievable with the amorphous silicon transistors. The processing technologies of amorphous silicon are more mature, especially for large area productions. However, due to the limitations of decreasing driving current and increasing threshold voltage, there are still limited applications of the amorphous silicon transistors for the driving circuits in the image display systems.

FIG. 1 shows a conventional driving circuit 10 of active matrix organic display system. The voltage control current drive 10 includes a first amorphous thin film silicon transistor 11 with the gate connected to the source of a second amorphous thin film silicon transistor 12. The gate of the second transistor 12 is connected to a scan line 15 and the drain is connected to data line 16. The source of the first transistor 11 is connected to a power terminal Vcc and the drain is connected to the cathode of a light emitting diode 14. The anode terminal of the light emitting diode 14 is connected to a low voltage Vcom. A capacitor 13 is connected between the Vcc and the source of the second transistor 12 that is also connected to the gate of the first transistor 11.

As the driver circuit 10 is activated to provide power to the light emitting diode 14, a current flows through the transistor 11 and that causes the electric charges to continuously move through the transistor 11. As a result, more and more charged particles for carrying electric charges are deposited on the insulation layers of the transistor 11. Due to the accumulated deposition of the particles for carrying charges, the threshold voltage of the transistor 11 increases gradually. In the meantime, over a period of operation to conduct current to the light emitting diode 14 to display image, the current that flows through the transistor 11 and the light emitting diode 14 gradually decreases.

Therefore, a need still exists in the art of design and manufacture of a driver circuit of an active matrix color image display to provide new and improved method of operation and driver circuit for the display system such that the limitations as now encountered can be overcome.

### SUMMARY OF THE PRESENT INVENTION

It is therefore an aspect of the present invention to provide new operational methods and new driver voltage control program for an active matrix display system for applying reverse biased voltage to the transistor in the driver circuit. The reverse biased voltage significant reduces the accumulation of charged particles on the insulation layer of the transistor. The problems of gradually reduction of LED driver current and increase of threshold voltage are therefore resolved.

Specifically, it is an aspect of the present invention to provide an improved driver voltage control configuration and method of operation by controlling the voltage applied to the transistor for passing a current to a light emitting diode. The voltage applied to the transistor is controlled to alternate to have reverse biased voltage when the light emitting diode is turned off. By applying a reverse biased voltage to the transistor the performance of the driver is improved because the electric charges accumulated on the insulation of the transistor is significantly reduced. The increase of threshold voltage and reduction of driver current caused by the charge accumulation are therefore circumvented.

Briefly, in a preferred embodiment, the present invention includes an image display system. The image display system includes a color display system that includes a light-emitting element driven by a driver circuit comprising a driver transistor to switch between a display-on and a display-off voltage for applying to the light-emitting element. The color display system further includes a voltage controller for controlling an application of a reverse bias voltage to the driver transistor during a time period when a display-off voltage is applied to the light-emitting element

This invention further discloses a method for configuring a color display system. The method includes a step of driving a light-emitting element by employing a driver circuit comprising a driver transistor to switch between a display-on and a display-off voltage for applying to the light-emitting element. The method further includes a step of controlling an application of a reverse bias voltage to the driver transistor while controlling the light-emitting element and the color display system for not displaying an image element from by the light-emitting element. In a preferred embodiment, the step of controlling an application of the reverse bias voltage further comprising a step of controlling an application of the reverse bias voltage to the driver transistor in a time period when the color display system is operating between two displaying frames. In another preferred embodiment, the step of controlling an application of the reverse bias voltage further includes a step of controlling an application of the reverse bias voltage to the driver transistor in a time period when the color display system is operating in a duty cycle period. In another preferred embodiment, the step of controlling an application of the reverse bias voltage further includes a step of controlling an application of the reverse bias voltage to the driver transistor in a time period when a display-off voltage is applied to the light-emitting element. In another preferred embodiment, the step of controlling an application of the reverse bias voltage further includes a step of controlling an application of a positive voltage on a scan line connected to the light-emitting element and applying a negative bias voltage on a data line connected to the light-emitting element for turning off the light-emitting element. In another preferred embodiment, the step of controlling an application of the reverse bias voltage further includes a step of controlling an application of a black voltage on a data line connected to the light-emitting element and applying an adjusted voltage to a high voltage Vcc and a low voltage Vcom of the light-emitting element to generate a reverse biased voltage between a gate and a source of the driver transistor. In another preferred embodiment, the step of controlling an application of the reverse bias voltage further includes a step of controlling an application of a black voltage on a data line connected to the light-emitting element and applying an adjusted voltage to a high voltage Vcc and the low voltage Vcom of the light-emitting to generate a reverse biased voltage between a gate and a source of the driver transistor. In another preferred embodiment, the step of controlling an application of the reverse bias voltage further includes a step of controlling an application of a reversed bias voltage through the light-emitting element to a drain of the driver transistor in a time period when the display-off voltage is applied to the light-emitting element.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIG. 1 is a circuit diagram of a conventional driver circuit of an active matrix color display system.

FIG. 2 is a circuit diagram of a driver circuit of this invention implemented with a controller executing a control program to apply a reverse biased voltage to a driver transistor.

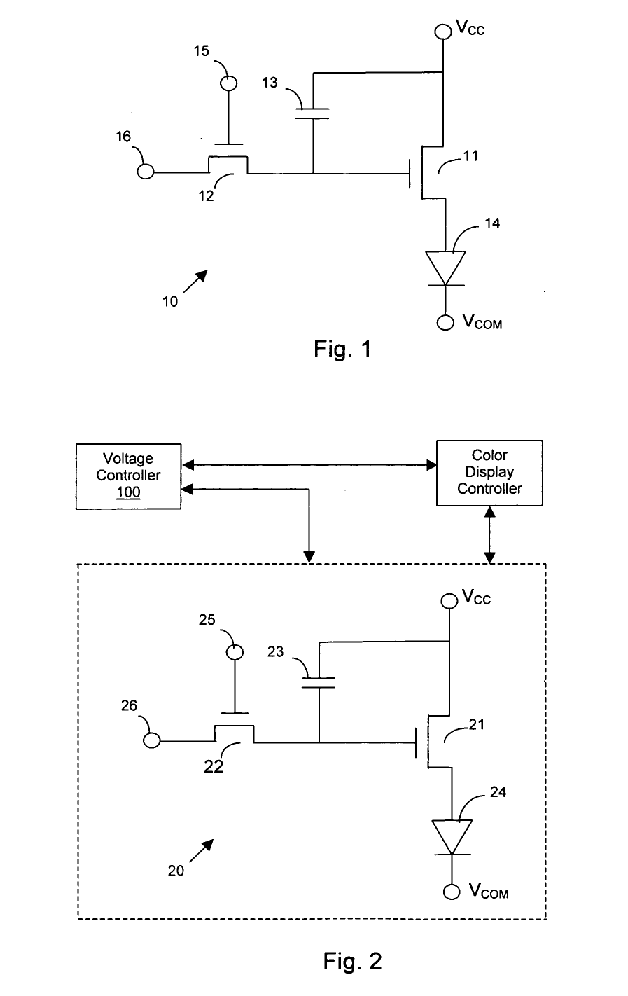

### DETAILED DESCRIPTION OF THE PREFERRED EMBODIMENT

FIG. 2 is a circuit diagram implemented in a voltage control current driver 20 for an active matrix organic display system of this invention. The voltage control current drive 20 includes a first amorphous thin film silicon transistor 21 with the gate connected to the source of a second amorphous thin film silicon transistor 22. The gate of the second transistor 22 is connected to a scan line 25 and the drain is connected to data line 26. The source of the first transistor 21 is connected to a power terminal Vcc and the drain is connected to the cathode of a light emitting diode 24. The anode terminal of the light emitting diode 24 is connected to a low voltage Vcom. The light emitting diode 24 can be an organic light emitting diode (OLED) or a polymer light emitting diode (PLED). A capacitor 23 is connected between the Vcc and the source of the second transistor 22 that is also connected to the gate of the first transistor 21.

As the driver circuit 20 is activated to provide power to the light emitting diode 24, a current flows through the transistor 21 and that causes the electric charges to continuously move through the transistor 21. As a result, more and more charged particles for carrying electric charges are deposited on the insulation layers of the transistor 21. Due to the accumulated deposition of the particles for carrying charges, the threshold voltage of the transistor 21 increases gradually. In the meantime, over a period of operation to conduct current to the light emitting diode 24 to display image, the current that flows through the transistor 21 and the light emitting diode 24 gradually decreases.

In order to overcome such difficulties, this invention discloses a method to eliminate the effects caused by the accumulated charge particles on the insulation layer of the transistor 21 due to continuous flow of electric current. The method is to apply a reverse biased voltage on the gate of the transistor 21 during the time when the light emitting diode 14 is turned off. According to a circuit diagram disclosed in FIG. 2, there are several operational processes available to apply such reverse biased voltage to the transistor 21. A first method is turn on the transistor 22 by applying a positive voltage on the scan line 25 and applying a reverse biased voltage on the data line 26 when the light emitting diode 24 is turned off. This method requires a direct circuit modification of the driver 20, or by implementing a voltage controller 100 provided to execute a voltage control program to apply the corresponding voltage bias to these terminals. A second method to apply a reverse biased voltage to the transistor is to apply a black voltage through the data line 26 to the driver circuit 20 such that the gate of the transistor 21 has a zero voltage. Meanwhile, the voltages of Vcc and Vcom are adjusted to generate a reverse biased voltage between the gate and the source, i.e., Vgs, or between the gate and the drain, i.e., Vgd. The reverse biased voltage is applied to reduce the accumulated charges on the gate insulation layer. This method does not require a modification of the driver circuit.

However, a voltage controller 100 connected to either the Vcc or Vcom terminal is necessary to control the biased voltage and the timing of voltage application on either the Vcc or the Vcom terminals. A third method is to apply a reverse biased voltage Vd through the LED 24 onto the drain terminal of the transistor 21 during the time when the LED is turned off and not required for illumination. This method can be applied either independently or in combination with either of the two methods discussed above by implementing a control program in the voltage controller 100. By applying one of the above three methods, the accumulated electric charges on the insulation layer of transistor 21 are reduced. The problems of gradually reduction of illumination current and gradually increase of threshold voltage are resolved.

According to above descriptions and FIG. 2, this invention discloses a color display system that includes a light-emitting element driven by a driver circuit includes a driver transistor to switch between a display-on and a display-off voltage for applying to the light-emitting element. The color display system further includes a voltage controller for controlling an application of a reverse bias voltage to the driver transistor during a time period when a display-off voltage is applied to the light-emitting element. In a preferred embodiment, the driver transistor further includes a gate for applying a gate voltage with a positive bias relative the to an input terminal to the light-emitting element in a time period when a display-on voltage is applied to the light-emitting element. And, the voltage controller further controls an application of the reverse bias voltage for applying a negative bias voltage to the gate relative to the input terminal of the light-emitting element in a time period when a display-off voltage is applied to the light-emitting element. In another preferred embodiment, the light-emitting element further includes a light-emitting diode with a cathode terminal connected to the driver transistor. In another preferred embodiment, the light-emitting element further includes a light-emitting diode with a cathode terminal connected to a drain terminal of the driver transistor and a anode terminal connected to a low voltage Vcom. And, the driver transistor further includes a source terminal connected to a high voltage Vcc. In another preferred embodiment, the driver circuit further includes a input transistor having a source connected to the gate of the driver transistor. And, the input transistor further includes a gate connected to a scan line and a source connected to a data line. In another preferred embodiment, the voltage controller controlling an application of a positive voltage on the scan line and applying a negative bias voltage on the data line for turning off the light-emitting element. In another preferred embodiment, the voltage controller controlling an application of a black voltage on the data line and applying an adjusted voltage to the high voltage Vcc and the low voltage Vcom to generate a reverse biased voltage between the gate and the source of the driver transistor. In another preferred embodiment, the In another preferred embodiment, the voltage controller controlling an application of a reversed bias voltage through the light-emitting element to the drain of the driver transistor in a time period when the display-off voltage is applied to the light-emitting element.

This invention further discloses a color display system that includes a light-emitting element driven by a driver circuit includes a driver transistor to switch between a display-on and a display-off voltage for applying to the light-emitting element. The color display system further includes a voltage controller for controlling an application of a reverse bias voltage to the driver transistor while controlling the light-emitting element and the color display system for not displaying an image element from by the light-emitting element. In a preferred embodiment, the voltage controller controlling an application of the reverse bias voltage to the driver transistor in a time period when the color display system is operating between two displaying frames. In another preferred embodiment, the voltage controller controlling an application of the reverse bias voltage to the driver transistor in a time period when the color display system is operating in a duty cycle period. In another preferred embodiment, the voltage controller controls an application of the reverse bias voltage to the driver transistor in a time period when a display-off voltage is applied to the light-emitting element

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A color display system comprising:
a light emitting element driven by a driver circuit comprising a driver transistor to switch between a display-on and a display-off voltage for applying to said light emitting element; and
a voltage controller for controlling an application of a reverse bias voltage to said driver transistor during a time period when a display-off voltage is applied to said light emitting element.

2. The color display system of claim 1 wherein:
said driver transistor further includes a gate for applying a gate voltage with a positive bias relative said to an input terminal to said light emitting element in a time period when a display-on voltage is applied to said light emitting element; and
said voltage controller further controlling an application of said reverse bias voltage for applying a negative bias voltage to said gate relative to said input terminal of said light emitting element in a time period when a display-off voltage is applied to said light emitting element.

3. The color display system of claim 1 wherein:
said light emitting element further comprising a light emitting diode with a cathode terminal connected to said driver transistor.

4. The color display system of claim 1 wherein:
said light emitting element further comprising a light emitting diode with a cathode terminal connected to a drain terminal of said driver transistor and a anode terminal connected to a low voltage Vcom; and
said driver transistor further includes a source terminal connected to a high voltage Vcc.

5. The color display system of claim 4 wherein:
said driver circuit further comprising a input transistor having a source connected to said gate of said driver transistor; and
said input transistor further comprising a gate connected to a scan line and a source connected to a data line.

6. The color display system of claim 5 wherein:
said voltage controller controlling an application of a positive voltage on said scan line and applying a negative bias voltage on said data line for turning off said light emitting element.

7. The color display system of claim 5 wherein:
said voltage controller controlling an application of a black voltage on said data line and applying an adjusted voltage to said high voltage Vcc and said low voltage Vcom to generate a reverse biased voltage between said gate and said source of said driver transistor.

7. The color display system of claim 5 wherein:
said voltage controller controlling an application of a black voltage on said data line and applying an adjusted voltage to said high voltage Vcc and said low voltage Vcom to generate a reverse biased voltage between said gate and said source of said driver transistor.

8. The color display system of claim 5 wherein:
said voltage controller controlling an application of a reversed bias voltage through said light emitting element to said drain of said driver transistor in a time period when said display-off voltage is applied to said light emitting element.

9. A color display system comprising:
a light emitting element driven by a driver circuit comprising a driver transistor to switch between a display-on and a display-off voltage for applying to said light emitting element; and
a voltage controller for controlling an application of a reverse bias voltage to said driver transistor while controlling said light emitting element and said color display system for not displaying an image element from by said light emitting element.

10. The color display system of claim 9 wherein:
said voltage controller controlling an application of said reverse bias voltage to said driver transistor in a time period when said color display system is operating between two displaying frames.

11. The color display system of claim 9 wherein:
said voltage controller controlling an application of said reverse bias voltage to said driver transistor in a time period when said color display system is operating in a duty cycle period.

12. The color display system of claim 9 wherein:
said voltage controller controlling an application of said reverse bias voltage to said driver transistor in a time period when a display-off voltage is applied to said light emitting element.

13. A method for configuring a color display system comprising:
driving a light emitting element by employing a driver circuit comprising a driver transistor to switch between a display-on and a display-off voltage for applying to said light emitting element; and
controlling an application of a reverse bias voltage to said driver transistor while controlling said light emitting element and said color display system for not displaying an image element from by said light emitting element.

14. The method of claim 13 wherein:
said step of controlling an application of said reverse bias voltage further comprising a step of controlling an application of said reverse bias voltage to said driver transistor in a time period when said color display system is operating between two displaying frames.

15. The method of claim 13 wherein:
said step of controlling an application of said reverse bias voltage further comprising a step of controlling an application of said reverse bias voltage to said driver transistor in a time period when said color display system is operating in a duty cycle period.

16. The method of claim 13 wherein:
said step of controlling an application of said reverse bias voltage further comprising a step of controlling an application of said reverse bias voltage to said driver transistor in a time period when a display-off voltage is applied to said light emitting element.

17. The method of claim 13 wherein:
said step of controlling an application of said reverse bias voltage further comprising a step of controlling an application of a positive voltage on a scan line connected to said light emitting element and applying a negative bias voltage on a data line connected to said light emitting element for turning off said light emitting element.

18. The method of claim 13 wherein:
said step of controlling an application of said reverse bias voltage further comprising a step of controlling an application of a black voltage on a data line connected to said light emitting element and applying an adjusted voltage to a high voltage Vcc and a low voltage Vcom of said light emitting element to generate a reverse biased voltage between a gate and a source of said driver transistor.

19. The method of claim 13 wherein:
said step of controlling an application of said reverse bias voltage further comprising a step of controlling an application of a black voltage on a data line connected to said light emitting element and applying an adjusted voltage to a high voltage Vcc and said low voltage Vcom of said light emitting to generate a reverse biased voltage between a gate and a source of said driver transistor.

20. The method of claim 13 wherein:
said step of controlling an application of said reverse bias voltage further comprising a step of controlling an application of a reversed bias voltage through said light emitting element to a drain of said driver transistor in a time period when said display-off voltage is applied to said light emitting element.
